(19) United States
(12) Patent Application Publication
(10) Pub. No.: US 2025/0130924 A1
(43) Pub. Date: Apr. 24, 2025

(54) METHOD FOR CHECKING THE DYNAMIC BEHAVIOR OF LLM-GENERATED CODE USING DIFFERENTIAL FUZZING

(71) Applicant: Robert Bosch GmbH, Stuttgart (DE)

(72) Inventors: Christopher Huth, Heilbronn (DE); Jesko Hecking-Harbusch, Leonberg (DE); Jochen Quante, Ludwigsburg (DE); Matthias Woehrle, Bietigheim-Bissingen (DE); Maximilian Schlund, Stuttgart (DE); Sebastian Ernesto Sierra Loaiza, Stuttgart (DE)

(21) Appl. No.: 18/914,854

(22) Filed: Oct. 14, 2024

(30) Foreign Application Priority Data
Oct. 19, 2023 (EP) 23 20 4625.0

(51) Int. Cl. G06F 11/36; G06F 8/30

(52) U.S. Cl. CPC G06F 11/3668; G06F 8/30

(57) ABSTRACT

A method for checking the dynamic behavior of code generated using a language model. Th method includes: providing a first executable file from a program code generated using a language model; providing a second executable file, wherein the second executable file is a previous first executable file or is an original source code of the program code; executing differential fuzzing using a fuzzer, wherein the fuzzer injects identical inputs into the first executable file and into the second executable file; monitoring the behavior and the output of the first executable file and the second executable file; outputting the program code if the fuzzing found no inconsistencies, no errors and/or no worse runtime behavior of the first executable file compared to the second executable file.

### CROSS REFERENCE

The present application claims the benefit under 35 U.S.C. § 119 of European Patent Application NO. EP 23204625.0 filed on Oct. 19, 2023, which is expressly incorporated herein by reference in its entirety.

### FIELD

Increasingly, program code is generated by means of language models, such as large language models (LLMs). This can be done for example as part of a language translation or automated program code translation or code refactoring.

The use of approaches for automated code generation, for example from LLMs, always brings challenges; for example, there is no guarantee that the code is correct, and there is no guarantee that the performance improves. For example, improvements may be generated for small code fragments, but this approach is not practical for larger code bases.

Working with larger code bases diminishes the usability of certain static methods, such as abstract interpretation, since correctness guarantees cannot be computed in a reasonable time or approximation is required, which then leads to over-approximation errors. In addition, static methods are hardly suitable for measuring software performance, e.g., runtime.

The biggest disadvantage of static methods that are “sound” (i.e., guaranteed not to miss anything), especially when first introduced into a software project, is that a multitude of warnings pop up, all of which must be fixed or marked as false positives. This cannot be prevented by the static method itself, otherwise it would lose its soundness (100% recall).

### SUMMARY

A first general aspect of the present invention relates to a method for checking the dynamic behavior of code generated by means of a language model.

According to an example embodiment of the present invention, the method comprises
providing a first executable file from a program code generated by means of a language model,
providing a second executable file, wherein the second executable file is a previous first executable file or is an original source code of the program code,
executing differential fuzzing by means of a fuzzer, wherein the fuzzer injects identical inputs into the first executable file and into the second executable file,
monitoring the behavior and the output of the first executable file and the second executable file,
outputting the program code if the fuzzing found no inconsistencies, no errors and/or no worse runtime behavior of the first executable file compared to the second executable file.

A second general aspect of the present invention relates to a method for checking the dynamic behavior of program code.

According to an example embodiment of the present invention, the method comprises
inputting a source code into a language model and generating a program code,
checking the program code by means of the method according to the first general aspect,
generating a reward for the language model, wherein the reward is based on the monitoring of the behavior and the output of the first executable file and the second executable file,
updating weights of the language model with the value of the reward.

A third general aspect of the present invention relates to a computer system designed to execute the method according to the first and/or the second general aspect of the present invention (or an embodiment thereof).

A fourth general aspect of the present invention relates to a computer program designed to execute the method according to the first general aspect of the present invention (or an embodiment thereof).

A fifth general aspect of the present invention relates to a computer-readable medium or signal which stores and/or contains the computer program according to the fourth general aspect of the present invention (or an embodiment thereof).

The techniques of the first, second, third, fourth and fifth general aspects of the present invention can have one or more of the following advantages in some situations.

The present invention uses differential fuzzing to compare, for example, the runtime and outputs of code generated by LLMs. This allows LLM-generated code to be tested effectively, i.e., automatically and quickly.

The present invention makes it possible to avoid existing tests, including, inter alia, unit tests to check whether the generated code patches are functionally correct, because fuzzing is used here. In reality, unit tests do not cover all cases of the software, and in some cases, unit tests are not available at all.

The present invention allows the dynamic behavior of code to be checked without using externally available benchmarks, such as BenchmarkDotNet. For external benchmarks to work, the code must be in a specific format so that it can be executed in this singular framework. The present disclosure improves this situation because no specific format is required. Instead, the code or software is compared to itself by means of differential fuzzing.

The present invention allows coverage as a quality measure for generated code, which in turn makes it possible to select better generated code. The test coverage is primarily a quality measure for the test. A high test coverage means that the tests have most likely covered all parts of the program. If no errors are found there, this in turn increases confidence in the quality of the code. For example, if the test coverage is re-input into the language model prompt, the language model could generate an LLM in the next generation or version of code, which is less complex. Less complex code would then be “better” to test, because fuzzing more easily achieves complete code coverage.

According to an example embodiment of the present invention, a method or system is provided which continuously generates code, verifies this code, subjects it to differential fuzzing, and (with a feedback loop) improves further generations of generated code.

The present invention is relevant to any product that is based on automated tests, in particular to dynamic testing methods, and any product that has legacy code or performance issues.

Some terms are used in the present disclosure in the following way.

A “language model” can in particular be a large language model (LLM), neural network, recurrent neural network (RNN), a transformer model, or a code model as a language model specialized for code, or even a very general language model that also comprises code. Also included are computer languages, and codes such as program codes of a computing device such as a computer. The language of the model can include not only natural languages but also artificial languages, such as programming languages.

In software development, “refactoring” of code refers to improving code structurally while maintaining observable program behavior, i.e., functionality. For example, readability, comprehensibility, maintainability and/or extensibility are to be improved with the aim of reducing the corresponding effort for error analysis and/or functional extensions. Typical refactoring includes, for example, renaming variables to self-explanatory names and/or extracting code parts into separate methods. Refactoring increases the quality of the code and therefore of the software.

“Testing,” “checking” or “comparing the source program code and the target program code” may include: formally checking the same behavior of the source program code and the target program code, for example by means of bounded model checking, tests in the source language, tests on contracts in the source language and/or syntactic and stylistic tests, fuzzing, mutation of the inputs of the test harness, derivation from contracts of the source language and/or the target language and/or derivation from a language model.

A “test harness” or test frame comprises a collection of software and test data used to systematically and automatically test a program under various environmental conditions. A test harness usually comprises a test execution engine, which is responsible for executing the test logic, and a test data repository or database, which contains the test scripts, test programs, and other test resources. Here, the test harness is generated automatically by adding differentiating tests to the database, for example. The test can be started with given or ready-made tests from the test database. The system can also generate tests automatically.

Here, data can be software code including test cases and harnesses plus additional (natural language) descriptions of the functionality or ranges of validity. In the case of language translation, by way of example, C is described here as the source language and Rust as the target language, but other combinations are also possible. The translation from C to Rust is interesting since Rust offers features in the field of safety-critical systems, but a lot of legacy code exists in other languages, especially C. In the case of refactoring, the source language and the target language are the same.

“Contracts” are part of contract-based programming or of a design according to a contract (“design by contract”). This is a software development concept with the aim of optimizing the interaction of individual program modules by defining formal contracts for the use of interfaces that go beyond their static definition.

The term “codebase” refers to the totality of the source code files belonging to a project as well as any associated configuration files. The codebase may also comprise various other files that are required for the compilation process, such as so-called makefiles.

“Fuzzing” or “fuzz testing” is the automated process of sending randomly generated inputs from a fuzzer to a target or target program and observing the response of the target. A “fuzzer” or “fuzzing engine” is a program that automatically generates inputs. It is therefore not necessarily connected to the software to be tested, nor is any instrumentation performed either. However, it has the ability to instrument code, generate test cases, and run programs to be tested. Conventional examples are AFL and libFuzzer.

Differential fuzzing is a software testing technique for detecting errors by sending the same input to a series of similar applications (or to different implementations of the same application) and observing differences in their execution.

A “fuzz target” is a software program or a function that is to be tested by fuzzing. A key feature of a fuzz target is that it is a binary file, a library, an application programming interface (API), or something else that can process bytes as an input.

“Glue code,” “wrapper,” “harness,” or “fuzz driver” link a fuzzer to a fuzz target.

A “fuzz test” is the combined version of a fuzzer and a fuzz target. A fuzz target can then be instrumented code, at the inputs of which a fuzzer is connected. A fuzz test can be executed. The fuzzer can also start, observe, and stop multiple running fuzz tests (generally hundreds or thousands per second), each with a somewhat different input generated by the fuzzer.

A “test case” is a specific input and a specific test run from a test harness or a fuzz test. In order to ensure reproducibility, runs of interest (finding new code paths or crashes) are saved.

An “instrumentation” is used to make the coverage metric observable, e.g., during compilation. “Instrumentation” is the insertion of instructions into a program in order to obtain feedback about the execution. It is usually realized by the compiler and can describe e.g., the code blocks reached during execution.

Coverage-guided fuzzing uses code coverage information as feedback during fuzzing in order to recognize whether an input has caused the execution of new code paths/blocks.

In “mutation-based fuzzing,” new inputs are created by taking a series of known inputs (corpus) and randomly applying mutations to them.

In “generation-based fuzzing,” new inputs are created from scratch, for example by using input models or input grammars. “Mutator” is a function that takes bytes as an input and outputs a small random mutation of the input.

A “corpus” (plural: corpora) is a set of inputs. Initial inputs are seeds.

### BRIEF DESCRIPTION OF THE DRAWINGS

FIG. 1 shows a flowchart illustrating the techniques of the present invention for checking dynamic behavior.

FIG. 2 schematically shows a system in which the techniques of the present invention for checking dynamic behavior can be used.

FIG. 3 schematically shows a fuzzing system in which the techniques of the present invention for checking dynamic behavior can be used.

FIG. 4 schematically shows a system in which the techniques of the present invention for checking dynamic behavior can be used.

FIG. 5 is a flowchart illustrating the techniques of the present invention for training a language model.

### DETAILED DESCRIPTION OF EXAMPLE EMBODIMENTS

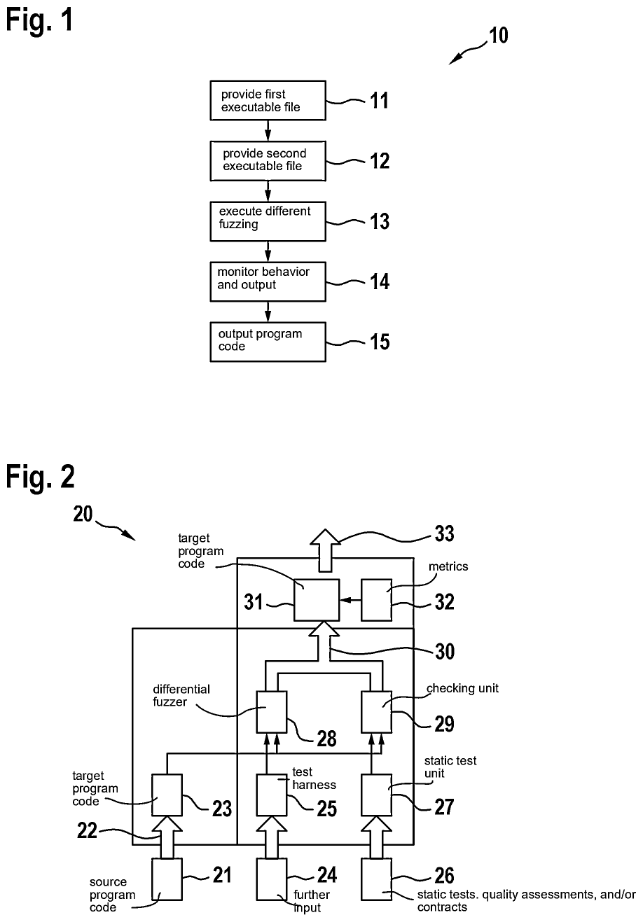

FIG. 1 is a flowchart describing a method 10 for checking the dynamic behavior of code generated by means of a language model. The generated code is generated, for example, in an automated program code translation from a source language to a target language. Alternatively, the program code can be generated by code refactoring.

The method 10 proposed in this disclosure is aimed at checking the dynamic behavior of software code generated by means of a language model. The dynamic behavior is checked during the runtime of the code or software. The software can be designed to control, regulate and/or monitor a technical system, in particular a cyber-physical system, in particular at least one computing unit of a vehicle. In particular, the software can be embedded software designed to be executed on an embedded (i.e., for example, task-specific) system.

In a first step, a first executable file that was generated by means of a language model is provided 11 from a program code. The provision comprises both simply the input of a program code or a file that has already been compiled into the method or the system and the inclusion of the generation or language model in the method or system. The provision can further comprise, for example, a tool that is well-coordinated with the fuzzer instrumenting program code for differential fuzzing. The checking of the dynamic behavior of the code or differential fuzzing can be carried out asynchronously to the generation of the program code or continuously. Alternatively, fuzzing can also be started after the static tests. When the language model generates the first code or when there are newer versions, the executable file is compiled and instrumented for dynamic fuzzing.

A second executable file is provided 12, wherein the second executable file is a previous first executable file or is an original source code of the program code. When the language model generates a new version of the code, the current first executable file becomes the second executable file and the new code is compiled into the first executable file. Optionally, additional executable files can be provided in addition to the second executable file. All executable files, for example three files, are subjected to differential fuzzing.

Optionally, the very first executable file created from the first translated code is kept for fuzzing. The executable file must be compiled and run successfully, without any obvious problems, of course. This executable file can be named Executable0. After a certain fuzz time during which the behavior and the outputs of the executable file are collected, improvements can then be observed compared to this first base version, i.e., Executable0.

The advantage of such a base version is that the overall improvements can be seen in comparison to a first version. This also provides clues as to when a code improvement cycle can be stopped, because code improvements should also follow an asymptotic behavior. This means there is a limit to code improvements and this limit is reached in decreasing increments over time. Another advantage is that Executable0 can be fuzzed whenever the differential fuzzing loop is inactive, for example, when the currently generated code cannot be compiled.

This is followed by execution 13 of differential fuzzing by a fuzzer, wherein the fuzzer injects identical inputs into the first executable file and into the second executable file. Differential fuzzing can be used in a gray-box environment so that different coverages can be best identified. A black-box setting is also possible, but may not perform as well.

This is followed by monitoring 14 the behavior and the output of the first executable file and the second executable file. For example, inconsistencies, worse runtime behavior or bugs are detected. The behavior of the program code can include the actual runtime for each test case. For example, the generated code is corrupted if the output of the first executable file and the second executable file do not match, if the runtime behavior of a newer (first) executable file degrades compared to the older (second) executable file, and/or if an error occurs.

The program code is then output 15 if the fuzzing has found no inconsistencies, no errors, or no worse runtime behavior of the first executable file compared to the second executable file. It is then assumed that the dynamic behavior of the generated code meets the requirements.

Optionally, static tests can be carried out in parallel. Static tests or checks may include, for example:
Contracts are either specified or extracted from the system environment.
In the case of Rust, static checks can also be provided by the compiler in other languages, e.g., also by linters, etc.
Bounded model checking and/or abstract interpretation, realized in commercial tools such as Astrée, or open source tools, such as CBMC.
Automatic creation of a bounded model checking setup, which statically compares target program code to given contracts.
Automatic creation of an abstract interpretation setup, which statically compares target program code to given contracts.
Automatic creation of a bounded model checking setup, which checks the source program code and the target program code for functional equality.

According to one embodiment, the method furthermore comprises a corpus with inputs for the fuzzer being provided, which corpus contains initial test cases from code repositories of the program code and/or from provided tests and test harnesses.

According to one embodiment, the method further comprises maintaining the corpus filled by all program codes and/or all executable software programs. As a result, differential fuzzing improves over time compared to a normal fuzzing campaign.

Another option is to reuse coverage and runtime information to guarantee that the generated code performs at least as well as older versions and does not contain easily found errors, something that fuzzing typically cannot guarantee.

According to one embodiment, the method further comprises feeding the behavior and/or output of the first executable file and/or the second executable file back to the fuzzer. This feedback loop can continuously improve the fuzzer.

According to one embodiment, the method furthermore comprises updating the program code or parts of the program code using the behavior of the program code, the output of the program code and/or the evaluation of the warning point, the updated program code being optionally fed back as an input for the language model.

As an alternative to the translation described, refactoring of the program code may be provided. Refactoring the program code can comprise or constitute changing the program code. The refactored program code can likewise again be a code of the software, in particular a source code of the software.

FIG. 2 schematically shows a computer system 20 in which the techniques of the present disclosure for checking the dynamic behavior of code generated by means of a language model can be used. The computer system 20 is designed to execute the method 10 according to FIG. 1 and the method 50 according to FIG. 5. The computer system 20 can be realized in hardware and/or software. Accordingly, the system shown in FIG. 2 can be regarded as a computer program designed to execute the method 10 according to FIG. 1 and the method 50 according to FIG. 5.

A source program code 21 in a source language, such as C, is provided to a language model 22, such as a large language model (LLM), for translation to a target language, such as Rust. The language model 22 generates a (target) program code 23 as a translation of the source program code 21. This area of the computer system 20 can be referred to as the generation area.

The language model is for example a large language model (LLM) into which data, such as a program code here, are inputted together with a question, such as a translation request or refactoring request here, via an input (prompt).

A further input 24 into the system 20 are tests and optionally a test harness in the source language. Alternatively or optionally, the tests and/or the test harness can be available in the target language. These inputs are fed to a test harness 25. The test harness 25 receives functions or tests in the target language.

Optionally, static tests, quality assessments and/or contracts 26 can be fed to a static test unit 27. There, they are managed for subsequent checks of the program code 23.

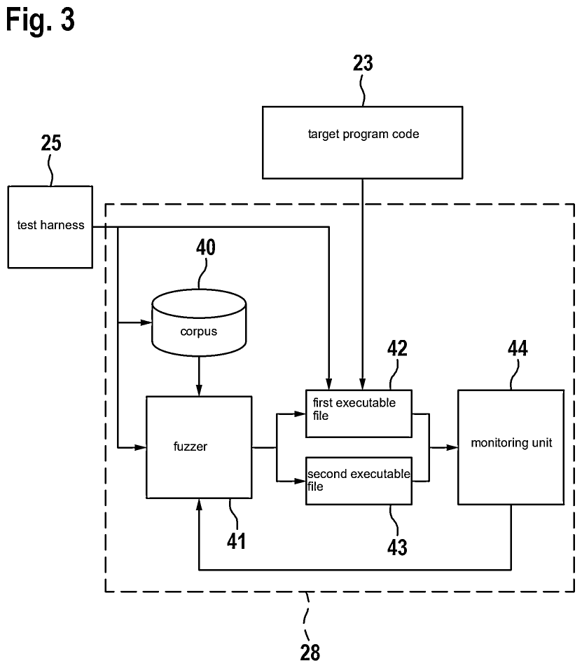

Inputs of a differential fuzzer 28 for directed fuzzing are linked to the language model 22 for inputting the program code 23 and to the test harness 25 for inputting test routines. In the fuzzer 28, the program code 23 is tested on the basis of the test harness 25 with the source program code 21, in particular to check the dynamic behavior of the program code 23. The fuzzer 28 and its function are described in more detail in connection with FIG. 3.

The generation of the program code 23 by the language model 22 can be repeated with changed conditions, such as a change in one or more hyperparameters such as a temperature parameter of the language model, transformations in the source program code and/or changes in the input to the language model, such as changes in the tasks or prompts. Variables in the code can also be renamed.

These measures generate a variance. This variance allows verification and improved quality assessment of the generated translations and also training of the language model by means of feedback. As part of the improved quality assessment, it can be determined which of the generated program codes 23 are more or less suitable. The fuzzer 28 then works with these variants of the program codes 23.

Inputs of a checking unit 29 are linked to the language model 22 for inputting the program code 23 and to the static test unit 27 for inputting static tests, quality assessments and/or contracts 26. In the checking unit 29, the program code 21 is checked by means of the static tests, quality assessments and/or contracts 26.

If the checks in the fuzzer 28 and in the checking unit 29 are completed successfully, a status message 30 is output that the program code 23 is OK. This area of the computer system 20 can be referred to as the check area.

The target program code 31 can be assessed in terms of its grade on the basis of metrics 32. The metrics 32 can comprise code quality metrics, test quality metrics, and/or the number of tests. If the assessment is successful, the program code and its quality or grade are output as an output 33. This area of the computer system 20 can be referred to as the quality assessment area.

Based on the assessment, a grade can be calculated. If multiple target program codes have been generated, the solutions can be provided to the user in order by grade.

The assessment of the program code can be carried out for example on the basis of code quality metrics, such as the length of the source code, the number of loops and/or the branch depth, test quality metrics such as the branch coverage, and/or the number of tests available or carried out.

FIG. 3 shows the differential fuzzer 28 in detail as well as the test harness 25 and the program code 23 as inputs for the fuzzer 28.

For differential fuzzing verification or testing, the fuzzer 28 comprises the following parts. A corpus 40 is filled with initial test cases from the code repositories (which are translated or refactored) and/or from the provided tests and test harnesses. For this purpose, the corpus 40 is linked to the test harness 25. The corpus 40 filled by all program codes 23 and/or all executable software programs can be maintained. This means that the content of the corpus is further built up over the iterations or versions of the program code 23 and no old data is deleted.

A fuzzer 41 takes generated code as input, e.g., for instrumentation. For this purpose, the fuzzer 41 is linked to the test harness 25. However, the main task of the fuzzer 41 is to generate inputs and inject them into a first executable file 42 and a second executable file 43. The compiled or executable files 42, 43 are generated from the program code 23. In addition, the two executable files 42, 43 can be instrumented for differential fuzzing. It is also possible for only one to be instrumented or for none to be instrumented. Instrumentation usually occurs when the executable file is built. There are also instrumentations which are only used at runtime. The instrumentation is done by another tool, e.g., a compiler. The test harness 25 can provide fuzz input to the first executable file 42. For example, an interface for fuzzing can be filled, glue code can be introduced, or the like.

The executable files are pushed forward, so to speak. When the language model generates a new version of the code, the current first executable file becomes the second executable file and the new code is compiled into the first executable file.

Accordingly, the second executable file is a previous first executable file or an original source code of the program code (at the start of the dynamic behavior check).

A monitoring unit 44 measures or monitors the coverage of the code during runtime, typically in a gray-box setting. This is then stored in the monitoring unit 44. The monitoring is a collection of runtime behavior, such as the actual runtime for each test case, and outputs from the executable file 43. All this is fed back to the fuzzer 42 in order to generate better test cases.

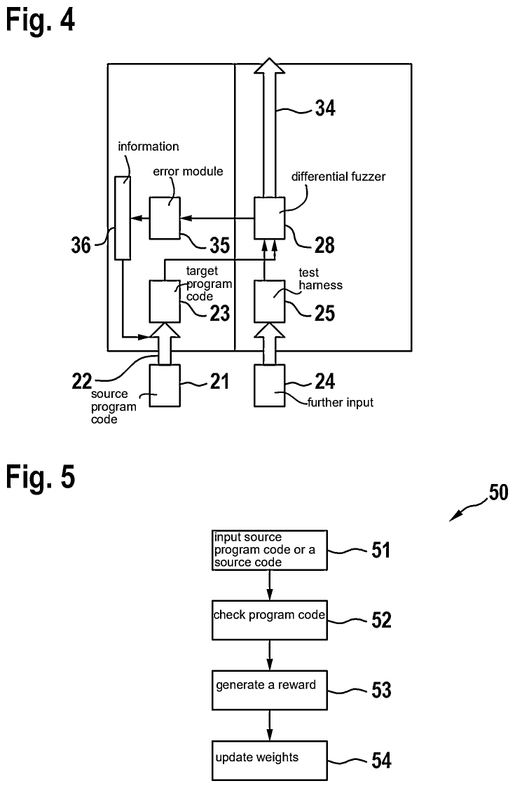

FIG. 4 schematically shows a computer system 20 in which the techniques of the present disclosure for checking the dynamic behavior of program code can be used. The computer system 20 can correspond to the computer system 20 of FIG. 2. The computer system 20 is designed to execute the method 10 according to FIG. 1 and the method 50 according to FIG. 5; in particular, the computer system 20 of FIG. 3 is designed to execute the training method 50 according to FIG. 5. The computer system 20 can be realized in hardware and/or software. Accordingly, the system shown in FIG. 3 can be regarded as a computer program designed to execute the method 10 according to FIG. 1 and the method 50 according to FIG. 5.

FIG. 4 shows an error handling mechanism of the computer system 20. If no program code 31 can be generated without errors, this will result in an error in the fuzzer 28. Accordingly, a message 34 is issued to reduce confidence in the check of the dynamic behavior of program code. In addition, the error and the associated program code 31 are stored in an error module 35.

From the error module 35, the best program code so far with the still existing errors is fed back as information 36 to the language model 22 in order to generate a better, ideally error-free target program code therewith. This reduces the reliability of checking the dynamic behavior of program code and is taken into account in the quality determination.

Optionally, this can relate not only to errors in the check area but also analogously to errors in the quality assessment area.

FIG. 5 is a flowchart illustrating a method 50 for training a language model. The language model is configured to automatically generate program code.

In summary, the code generated by the language model is returned as feedback to the language model in order to generate a new generation of source code. The idea is that already suitable (or better) code can then be fine-tuned with regard to monitoring output and behavior output using an updated prompt that contains the new code. For example, if already good code only has runtime problems at certain points, these points can be fed back to the language model.

In a first step of the method, the source program code or a source code is inputted 51 into a language model and a program code is generated. The language model can already be pre-trained and, where appropriate, also already be fine-tuned.

Alternatively, a new, untrained language model can also be used to start with. The training here is based on reinforcement learning. Training takes place in a training environment, for example with PPO (proximal policy optimization).

Furthermore, the program code of the predictive target program code is checked 52 by means of the method 10 as described above with reference to FIG. 1.

Then, a reward is generated 53 for the language model, wherein the reward is based on the monitoring 14 of the behavior and the output of the first executable file 42 and the second executable file 43. For example, a low rating can be given if inconsistencies, errors and/or worse runtime behavior are found in the first executable file 42 compared to the second executable file 43. A high rating can be given if no inconsistencies, no errors and/or no worse runtime behavior of the first executable file 42 compared to the second executable file 43 are found.

Finally, the weights of the language model are updated 54 with the value of the reward. The result of the method is a language model that is better trained on new unlabeled data (here, for example, C code from an engine controller), i.e., provides more reliable translations.

According to one embodiment, the method furthermore comprises approximating the reward by executing only one test of the tests of the automated checking. This makes it possible to accelerate the training.

What is claimed is:

1. A method for checking a dynamic behavior of code generated using a language model, the method comprising the following steps:
providing a first executable file from a program code generated using a language model;
providing a second executable file, wherein the second executable file is a previous first executable file or is an original source code of the program code;
executing differential fuzzing using a fuzzer, wherein the fuzzer injects identical inputs into the first executable file and into the second executable file;
monitoring a behavior and an output of the first executable file and the second executable file; and
outputting the program code when the fuzzing found no inconsistencies and/or no errors and/or no worse runtime behavior of the first executable file compared to the second executable file.

2. The method according to claim 1, wherein the program code is instrumented for differential fuzzing.

3. The method according to claim 1, wherein a corpus with inputs for the fuzzer is provided, which corpus contains initial test cases: (i) from code repositories of the program code and/or (ii) from provided tests and test harnesses.

4. The method according to claim 3, wherein the corpus filled by all program codes and/or all executable software programs is maintained.

5. The method according to claim 1, wherein the behavior of the first executable file and the second executable file includes and actual runtime for each test case.

6. The method according to claim 1, wherein the generated code is corrupted when the output of the first executable file and the second executable file does not match, and/or when the runtime behavior of a newer executable file deteriorates and/or when an error occurs.

7. The method according to claim 1, wherein the behavior and/or the output of the first executable file and/or the second executable file is fed back to the fuzzer.

8. The method according to claim 1, wherein the program code or parts of the program code are updated using a behavior of the program code and/or an output of the program code, and wherein the updated program code is fed back as an input for the language model.

9. A method for training a language model configured to check the dynamic behavior of program code, comprising the following steps:
inputting a source code into a language model and generating a program code;
checking the program code by:
providing a first executable file from the program code generated using the language model;
providing a second executable file, wherein the second executable file is a previous first executable file or is an original source code of the program code,
executing differential fuzzing using a fuzzer, wherein the fuzzer injects identical inputs into the first executable file and into the second executable file,
monitoring a behavior and an output of the first executable file and the second executable file, and
outputting the program code when the fuzzing found no inconsistencies and/or no errors and/or no worse runtime behavior of the first executable file compared to the second executable file;
generating a reward for the language model, wherein the reward is based on the monitoring of the behavior and the output of the first executable file and the second executable file; and
updating weights of the language model with a value of the reward.

10. The method according to claim 9, wherein the reward is approximated by performing only one verification.

11. A computer system configured to check a dynamic behavior of code generated using a language model, the computer system configured to:
provide a first executable file from a program code generated using a language model;
provide a second executable file, wherein the second executable file is a previous first executable file or is an original source code of the program code;
execute differential fuzzing using a fuzzer, wherein the fuzzer injects identical inputs into the first executable file and into the second executable file;
monitor a behavior and an output of the first executable file and the second executable file; and
output the program code when the fuzzing found no inconsistencies and/or no errors and/or no worse runtime behavior of the first executable file compared to the second executable file.

12. A non-transitory computer-readable medium on which is stored a computer program for checking a dynamic behavior of code generated using a language model, the computer program, when executed by a computer-causing the computer to perform the following steps:
providing a first executable file from a program code generated using a language model;
providing a second executable file, wherein the second executable file is a previous first executable file or is an original source code of the program code;
executing differential fuzzing using a fuzzer, wherein the fuzzer injects identical inputs into the first executable file and into the second executable file;
monitoring a behavior and an output of the first executable file and the second executable file; and
outputting the program code when the fuzzing found no inconsistencies and/or no errors and/or no worse runtime behavior of the first executable file compared to the second executable file.
